(19) United States
(12) Patent Application Publication
(10) Pub. No.: US 2010/0232853 A1
(43) Pub. Date: Sep. 16, 2010

(54) IMAGE FORMING APPARATUS

(76) Inventors: Keiji SASAKI, Saitama-shi (JP); Hideki Matsumoto, Saitama-shi (JP)

Correspondence Address: MORGAN LEWIS & BOCKIUS LLP, 1111 PENNSYLVANIA AVENUE NW, WASHINGTON, DC, 20004, US

(21) Appl. No.: 12/632,358

(22) Filed: Dec. 7, 2009

(30) Foreign Application Priority Data
Mar. 10, 2009 (JP) 2009-056091
Apr. 6, 2009 (JP) 2009-092247

(51) Int. Cl. G03G 15/00

(52) U.S. Cl. 399/381

(57) ABSTRACT

An image forming apparatus includes: an image holder that holds an image; a conveying member that conveys an image transferred from the image holder or a recording medium with the image transferred from the image holder thereto; an image holder supporting part that supports the image holder; and a conveying member supporting part that is a separate body from the image holder supporting part and supports the conveying member such that the conveying member is openable and closable.

### CROSS-REFERENCE TO RELATED APPLICATIONS

This application is based on and claims priority under 35 USC 119 from Japanese Patent Application Nos. 2009-056091 filed Mar. 10, 2009 and 2009-092247 filed Apr. 6, 2009.

### BACKGROUND

### Technical Field

The present invention relates to an image forming apparatus.

### SUMMARY

According to an aspect of the invention, there is provided an image forming apparatus including: an image holder that holds an image; a conveying member that conveys an image transferred from the image holder or a recording medium with the image transferred from the image holder thereto; an image holder supporting part that supports the image holder; and a conveying member supporting part that is a separate body from the image holder supporting part and supports the conveying member such that the conveying member is openable and closable.

### BRIEF DESCRIPTION OF THE DRAWINGS

Exemplary embodiments of the present invention will be described in detail based on the following figures, wherein:

FIG. 1 is a perspective view illustrating an image forming apparatus according to a first exemplary embodiment of the invention;

FIG. 2 is a sectional view illustrating the image forming apparatus shown in FIG. 1;

FIG. 3 is a side view illustrating the state where a main opening/closing part is opened with respect to an image forming apparatus main body shown in FIG. 1, and the state where photoreceptor units are mounted in or removed from the image forming apparatus main body;

FIG. 4 is a sectional view illustrating the photoreceptor unit used in the image forming apparatus shown in FIG. 1;

FIG. 5 is a plan view in schematic form illustrating the photoreceptor unit shown in FIG. 4;

FIGS. 6A and 6B are views illustrating the operation of a shutter member of the photoreceptor unit shown in FIG. 4, wherein FIG. 6A is a sectional view illustrating the state where the shutter member is in a second position, and FIG. 6B is a sectional view illustrating the state where the shutter member is in a first position;

FIG. 7 is a plan view in schematic form illustrating a development device of the image forming apparatus shown in FIG. 1;

FIG. 8 is a perspective view illustrating a belt unit of the image forming apparatus shown in FIG. 1;

FIG. 9 is a plan view in schematic form illustrating a main body frame of the image forming apparatus shown in FIG. 1;

FIG. 10 is a side view illustrating the main body frame of the image forming apparatus shown in FIG. 1;

FIG. 11 is a perspective view illustrating the main body frame of the image forming apparatus shown in FIG. 1;

FIG. 12 is a perspective view illustrating a rear plate of the main body frame shown in FIG. 11;

FIG. 13 is a sectional view illustrating a hinge of the image forming apparatus shown in FIG. 1;

FIG. 14 is a perspective view illustrating an intermediate transfer belt unit of an image forming apparatus according to a second exemplary embodiment of the invention;

FIG. 15 is a plan view in schematic form illustrating a latent image forming device of the image forming apparatus according to the second exemplary embodiment of the invention;

FIG. 16 is a first plan view in schematic form illustrating an image forming apparatus main body of the image forming apparatus according to the second exemplary embodiment of the invention;

FIG. 17 is a second plan view in schematic form illustrating the image forming apparatus main body of the image forming apparatus according to the second exemplary embodiment of the invention;

FIG. 18 is a first side view, seen from the right side, of a right side plate of the image forming apparatus according to the second exemplary embodiment of the invention; and

FIG. 19 is a second side view, seen from the right side, of the right side plate of the image forming apparatus according to the second exemplary embodiment of the invention.

### DETAILED DESCRIPTION

Next, exemplary embodiments of the present invention will be described with reference to the accompanying drawings.

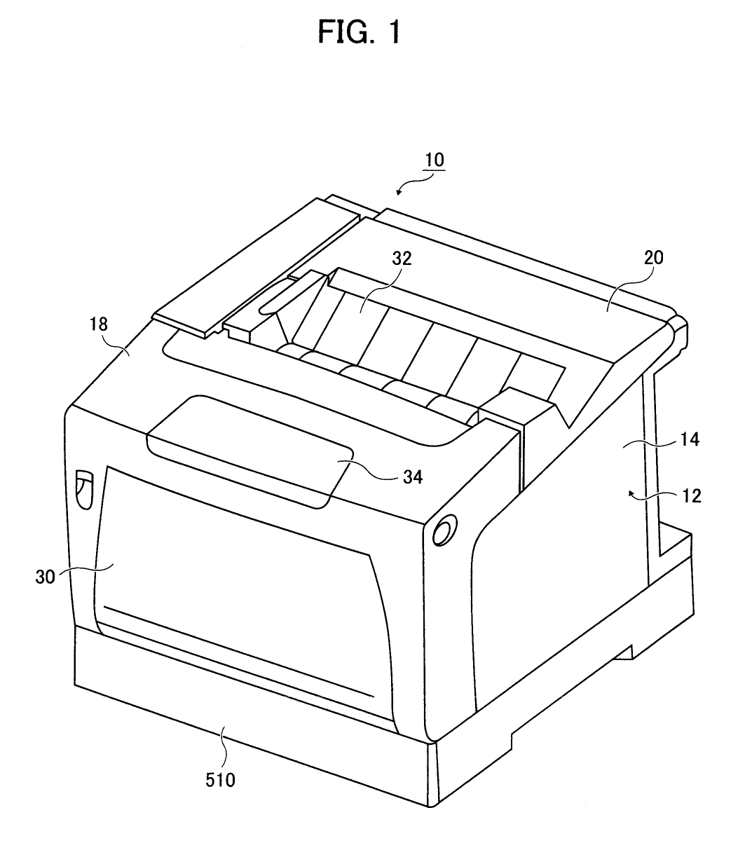

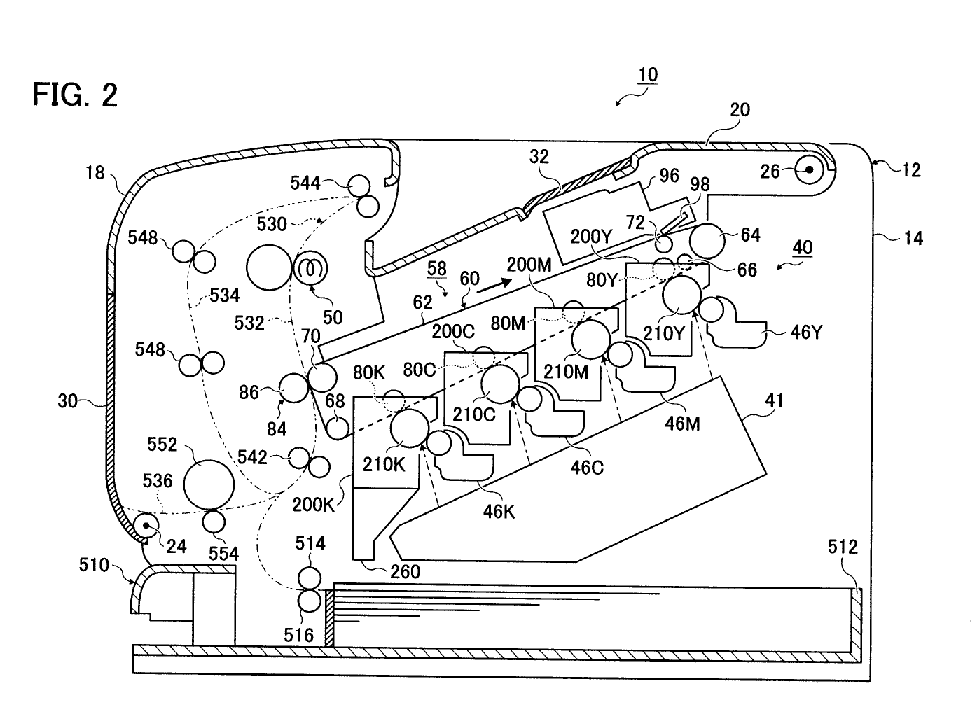

FIGS. 1 and 2 illustrate an image forming apparatus 10 according to a first exemplary embodiment of the invention.

As shown in FIGS. 1 and 2, the image forming apparatus 10 includes an image forming apparatus main body 12. On the image forming apparatus main body 12, a front opening/closing part 18 and a main opening/closing part 20 are mounted so as to be openable and closable with respect to the image forming apparatus main body 12.

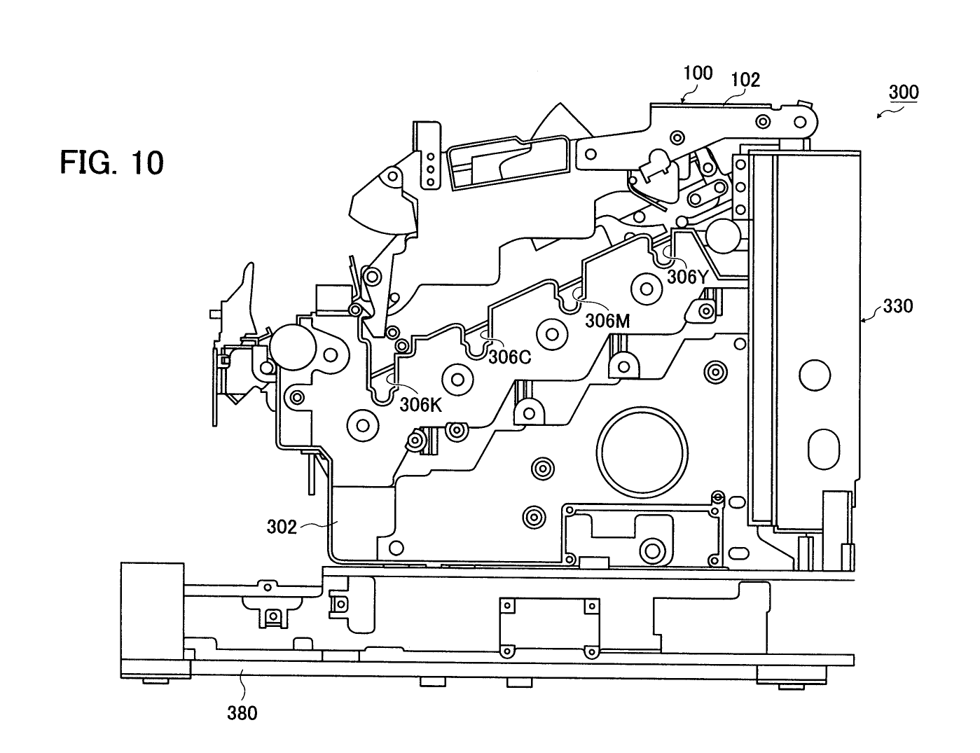

The image forming apparatus main body 12 includes a main body frame 300 to be described later (see FIG. 10), and an exterior cover 14 mounted over the main body frame 300.

The front opening/closing part 18 pivots about a center shaft 24 to open and close with respect to the image forming apparatus main body 12. Also, the front opening/closing part 18 is provided with an operating part 34. The operating part 34 includes, for example, a numeric keypad for inputting the number of recording media to form images thereon, and a start button to be operated at the start of image formation.

Furthermore, on the front opening/closing part 18, a supply opening/closing part 30 is mounted in an openable and closable manner with respect to the front opening/closing part 18. The supply opening/closing part 30 is normally closed with respect to the front opening/closing part 18, as shown in FIGS. 1 and 2. When using a recording medium different from the recording medium stored in a recording medium feeding device 510 to be described later, the supply opening/closing part 30 is opened with respect to the front opening/closing part 18.

The main opening/closing part 20 pivots about a center shaft 26 to open and close with respect to the image forming apparatus main body 12. The main opening/closing part 20 is normally closed with respect to the image forming apparatus main body 12. When mounting or removing photoreceptor units 200Y, 200M, 200C, and 200K to be described later in or from the image forming apparatus main body 12, the main opening/closing part 20 is opened. In order to prevent a support roller 70, an intermediate transfer belt 62 and the like, to be described later, mounted on the main opening/closing part 20, from interfering with the front opening/closing part 18, the front opening/closing part 18 is opened before opening the main opening/closing part 20. Also, when closing the front opening/closing part 18 with respect to the image forming apparatus main body 12, the main opening/closing part 20 is closed with respect to the image forming apparatus main body 12 before closing the front opening/closing part 18.

Also, on the main opening/closing part 20, a sub opening/closing part 32 is mounted in an openable and closable manner with respect to the main opening/closing part 20. The sub opening/closing part 32 is openable and closable independently from the main opening/closing part 20, and can be in an open state with respect to the main opening/closing part 20 being in a closed state with respect to the image forming apparatus main body 12. The sub opening/closing part 32 is opened when mounting or removing the whole or part of a cleaning device 96 to be described later in or from the image forming apparatus main body 12. Also, the upper surface of the sub opening/closing part 32 is used as an ejection part for ejecting a recording medium with an image formed thereon.

In the image forming apparatus main body 12, an image forming part 40 for forming an image on a recording medium is provided. The image forming part 40 includes, for example, the four photoreceptor units 200Y, 200M, 200C, and 200K.

The photoreceptor units 200Y, 200M, 200C, and 200K, serving as image forming structures, include photoreceptor drums 210Y, 210M, 210C, and 210K, respectively, and can be removably mounted in the image forming apparatus main body 12. The photoreceptor units 200Y, 200M, 200C, and 200K are disposed in this order from the rear (the right side in FIG. 2) of the image forming apparatus main body 12. The details of the photoreceptor units 200Y, 200M, 200C, and 200K will be described later.

The photoreceptor drums 210Y, 210M, 210C, and 210K are used as image holders for holding images.

Also, the image forming part 40 includes a latent image forming device 41. The latent image forming device 41 emits light on the photoreceptor drums 210Y, 210M, 210C, and 210K to thereby form latent images on respective surfaces of the photoreceptor drums 210Y, 210M, 210C, and 210K.

Furthermore, the image forming part 40 includes development devices 46Y, 46M, 46C, and 46K. The development device 46Y develops, with yellow toner stored therein, the latent image formed on the photoreceptor drum 210Y. The development device 46M develops, with magenta toner stored therein, the latent image formed on the photoreceptor drum 210M. The development device 46C develops, with cyan toner stored therein, the latent image formed on the photoreceptor drum 210C. The development device 46K develops, with black toner stored therein, the latent image formed on the photoreceptor drum 210K.

Also, the image forming part 40 includes a transfer device 58. The transfer device 58 includes an intermediate transfer belt unit 60 and a second transfer device 84. The intermediate transfer belt unit 60 includes the intermediate transfer belt 62.

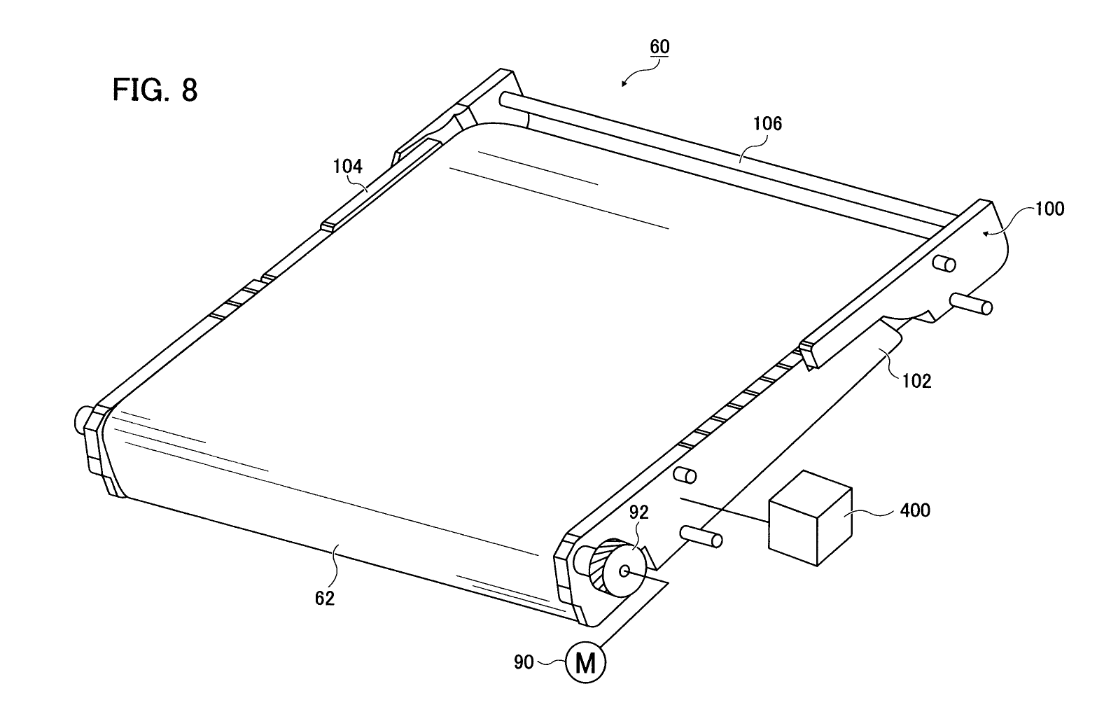

The intermediate transfer belt 62 is used as a conveying member for conveying images (toner images) transferred from the photoreceptor drums 210Y, 210M, 210C, and 210K. Also, the intermediate transfer belt 62 is endless, and stretched over support rollers 64, 66, 68, 70, and 72 so as to rotate in the direction shown by the arrow in FIG. 2. Through a gear 92 to be described later (see FIG. 8), drive is transmitted from a motor 90 to be described later (see FIG. 8) to the support roller 70. The support roller 70 receives the drive transmitted from the motor 90 to rotate, thereby transmitting the drive to the intermediate transfer belt 62.

Also, the intermediate transfer belt unit 60 includes first transfer rollers 80Y, 80M, 80C, and 80K serving as first transfer devices. The first transfer rollers 80Y, 80M, 80C, and 80K transfer a yellow toner image, a magenta toner image, a cyan toner image, and a black toner image formed on the surfaces of the photoreceptor drums 210Y, 210M, 210C, and 210K, respectively onto the intermediate transfer belt 62.

The intermediate transfer belt unit 60 will be further explained later.

The second transfer device 84 includes a second transfer roller 86. The second transfer roller 86 transfers the yellow, magenta, cyan, and black toner images transferred onto the intermediate transfer belt 62 further onto a recording medium.

The transfer device 58 includes the cleaning device 96. The cleaning device 96 includes a scraping member 98. The scraping member 98 scrapes off the toners of the respective colors remaining on the surface of the intermediate transfer belt 62 after the toner images of the respective colors are transferred onto the recording medium by the second transfer roller 86. The toners scraped off by the scraping member 98 are recovered within a main body of the cleaning device 96. The cleaning device 96 is adapted to be removably mounted in the image forming apparatus main body 12 through an opening to be formed by opening the sub opening/closing part 32.

Among the members constituting the transfer device 58, the intermediate transfer belt unit 60 and the cleaning device 96 are mounted on the main opening/closing part 20, and the second transfer roller 86 is mounted on the image forming apparatus main body 12.

A fixing device 50 for fixing the toner image transferred onto a recording medium by the second transfer roller 86 to the recording medium is provided in the image forming apparatus main body 12.

Also, a recovery container 260 is provided in the image forming apparatus main body 12. The surplus developer discharged from the development devices 46Y, 46M, 46C, and 46K is recovered into the recovery container 260. The recovery container 260 is integral with, for example, the photoreceptor unit 200K.

Also, the recording medium feeding device 510 for feeding recording media to the image forming part 40 is mounted in the image forming apparatus main body 12. The recording medium feeding device 510 can be pulled out on the front side (the left side in FIG. 2) of the image forming apparatus main body 12, and recording media are supplied with the recording medium feeding device 510 pulled out of the image forming apparatus main body 12.

The recording medium feeding device 510 includes a recording medium container 512 for storing recording media such as plain paper in a stacked state. Also, the recording medium feeding device 510 includes a feed roller 514 for extracting the top recording medium stored in the recording medium container 512 to convey the extracted recording medium to the image forming part 40. Further, the recording medium feeding device 510 includes a retard roller 516 that is used for separating recording media to thereby prevent plural recording media from being conveyed to the image forming part 40 in an overlapping state.

Also, a conveyance path 530 for use in conveyance of a recording medium is formed in the image forming apparatus main body 12. The conveyance path 530 includes a main conveyance path 532, a reverse conveyance path 534, and a sub conveyance path 536.

The main conveyance path 532 is used for conveying a recording medium fed from the recording medium feeding device 510 to the image forming part 40 to eject the recording medium with an image formed thereon to the outside of the image forming apparatus main body 12. The above-described feed roller 514 and retard roller 516, a registration roller 542, the above-described second transfer roller 86, the above-described fixing device 50, and a eject roller 544 are disposed along the main conveyance path 532, in this order from the upstream side in a direction to convey a recording medium.

The registration roller 542 temporarily stops the recording medium conveyed from the recording medium feeding device 510, at a leading edge of the recording medium, and thereafter sends the recording medium to the second transfer roller 86 in accordance with the timing at which the toner images of the respective colors are transferred onto the intermediate transfer belt 62.

The eject roller 544 ejects the recording medium with the toners of the respective colors fixed thereon by the fixing device 50 to the outside of the image forming apparatus main body 12.

The reverse conveyance path 534 serves as a conveyance path used for reversing a recording medium with a toner image fixed onto one side thereof to convey again the recording medium to the image forming part 40. Along the reverse conveyance path 534, for example, two reverse feed rollers 548 and 548 are disposed. On the reverse conveyance path 534, the eject roller 544 reversely rotates while pinching a rear edge of the recording medium, thereby feeding the recording medium with the rear edge of the recording medium directed forward. The fed recording medium is conveyed to an upstream position of the registration roller 542 through the reverse feed rollers 548 and 548.

The sub conveyance path 536 serves as a conveyance path for feeding a recording medium different from the recording medium stored in the recording medium feeding device 510 to the image forming part 40. The recording medium is fed from the front side of the image forming apparatus main body 12 to the sub conveyance path 536, with the supply opening/closing part 30 opened. A feed roller 552 and a retard roller 554 are provided along the sub conveyance path 536. The feed roller 552 conveys the recording medium fed to the sub conveyance path 536, to the image forming part 40. The retard roller 554 is used for separating recording media fed to the sub conveyance path 536 to thereby prevent plural recording media from being conveyed to the image forming part 40 in an overlapping state.

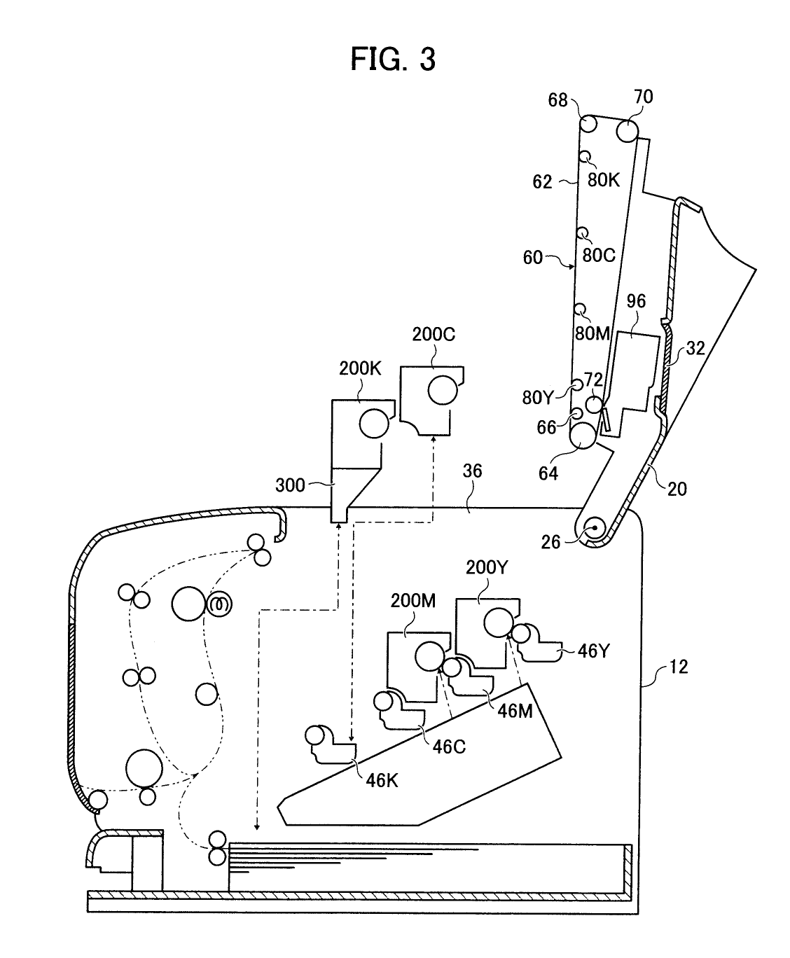

FIG. 3 illustrates the state where the main opening/closing part 20 is opened with respect to the image forming apparatus main body 12, and the state where the photoreceptor units 200 are mounted in or removed from the image forming apparatus main body 12.

As shown in FIG. 3, when the main opening/closing part 20 is opened with respect to the image forming apparatus main body 12, the intermediate transfer belt unit 60 and the cleaning device 96 of the transfer device 58 are moved along with the main opening/closing part 20. In other words, the intermediate transfer belt unit 60 and the cleaning device 96 are opened and closed with respect to the image forming apparatus main body 12, integrally with the main opening/closing part 20.

When the main opening/closing part 20, the intermediate transfer belt unit 60, and the cleaning device 96 are integrally opened with respect to the image forming apparatus main body 12, an opening 36 is formed on the image forming apparatus main body 12. Through the opening 36, the photoreceptor units 200Y, 200M, 200C, and 200K are removably mounted in the image forming apparatus main body 12. The recovery container 260 is integral with the photoreceptor unit 200K, as described above. Therefore, the recovery container 260 is removably mounted in the image forming apparatus main body 12, integrally with the photoreceptor unit 200K.

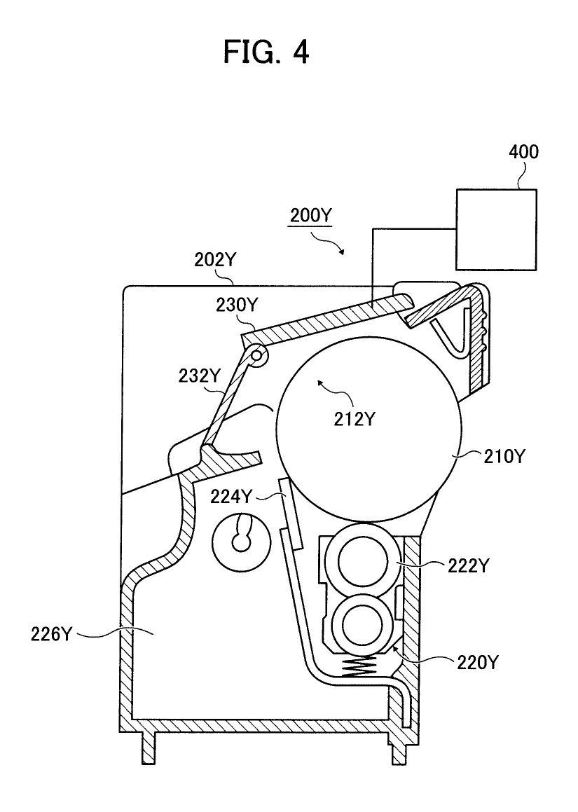

FIG. 4 illustrates the photoreceptor unit 200Y. It is to be noted that the photoreceptor units 200M, 200C, and 200K have substantially the same configuration as the photoreceptor unit 200Y, except that the colors of the developers to be used are different. Therefore, the photoreceptor units 200M, 200C, and 200K will not be described.

As shown in FIG. 4, the photoreceptor unit 200Y includes a photoreceptor unit main body 202Y, and the photoreceptor drum 210Y described above is mounted in the photoreceptor unit main body 202Y. A part of the photoreceptor drum 210Y is exposed, as an exposed part 212Y, to the outside of the photoreceptor unit main body 202Y. The photoreceptor unit main body 202Y is used as a housing with the photoreceptor drum 210Y mounted so as to be partially exposed.

In the photoreceptor unit main body 202Y, a charging device 220Y for uniformly charging the surface of the photoreceptor drum 210Y is mounted. The charging device 220Y includes a charging roller 222Y in contact with the photoreceptor drum 210Y. On the surface of the photoreceptor drum 210Y uniformly charged by the charging device 220Y, a latent image is written by the latent image forming device 41 (see FIG. 1).

Also, a scraping member 224Y serving as a cleaning device is mounted in the photoreceptor unit main body 202Y. The scraping member 224Y scrapes off yellow toner remaining on the surface of the photoreceptor drum 210Y after the transfer of a yellow toner image onto the intermediate transfer belt 62 by the first transfer roller 80Y (see FIG. 2).

In the photoreceptor unit main body 202Y, a recovery chamber 226Y is also provided for recovering the yellow toner scraped off the surface of the photoreceptor drum 210Y by the scraping member 224Y.

Further, a shutter member 230Y is mounted in the photoreceptor unit main body 202Y through, for example, a support member 232Y. The shutter member 230Y is used as a moving member. Also, the shutter member 230Y is connected to a link mechanism 400, and connected to the intermediate transfer belt unit 60 described above through the link mechanism 400.

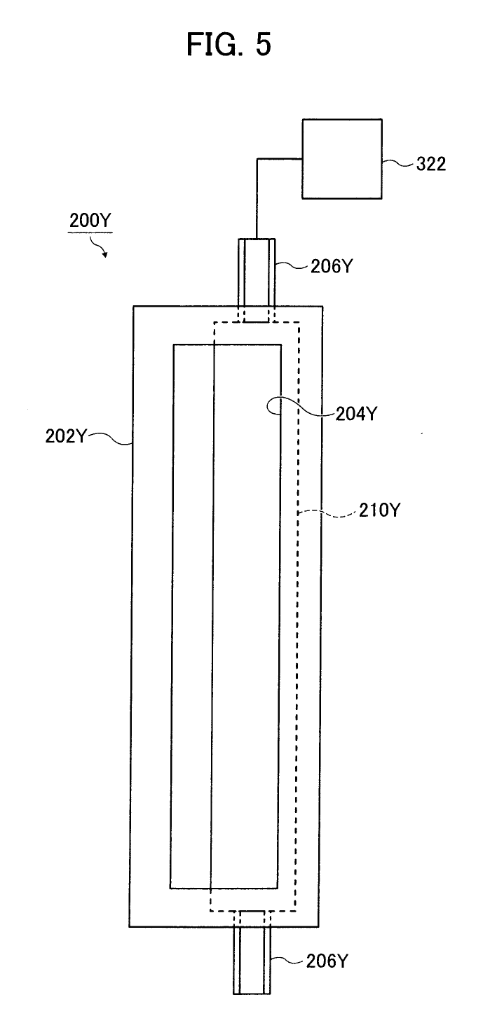

FIG. 5 is a plan view in schematic form illustrating the photoreceptor unit 200Y.

As shown in FIG. 5, an opening 204Y is formed on the photoreceptor unit main body 202Y, and a part of the photoreceptor drum 210Y is adapted to be exposed from the photoreceptor unit main body 202Y through the opening 204Y. Also, the photoreceptor drum 210Y is rotatably supported by bearings 206Y and 206Y in the photoreceptor unit main body 202Y.

The bearings 206Y and 206Y are each made of a highly heat-conductive material such as metal or heat conductive resin. More specifically, a material having a thermal conductivity of 10 W/m·K or more, and 100 W/m·K or more may be used. Here, brass having a thermal conductivity of 106 W/m·K can be given as an example of the materials for the bearings 206Y and 206Y. For thermal conductivity measurement, the steady-state heat flow meter technique, defined by the American Society for Testing and Materials (ASTM) E1530, can be used.

Furthermore, as shown in FIG. 5, a motor 322 serving as a driving source is connected to, for example, a left shaft of the photoreceptor drum 210Y, and the photoreceptor drum 210Y receives drive transmitted from the motor 322 to rotate.

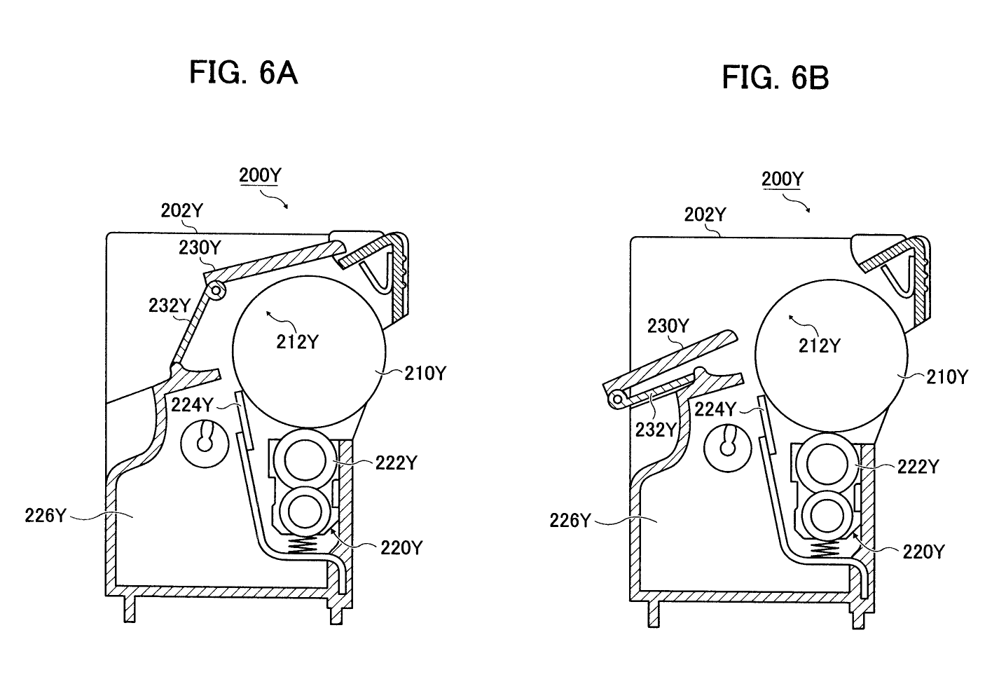

FIGS. 6A and 6B illustrate the operations of the shutter member 230Y. The shutter member 230Y moves between the position shown in FIG. 6A as a second position and the position shown in FIG. 6B as a first position.

The second position shown in FIG. 6A corresponds to the position (hereinafter referred to as a covering position) where the shutter member 230Y covers the exposed part 212Y of the photoreceptor drum 210Y. On the other hand, the first position shown in FIG. 6B corresponds to the position (hereinafter referred to as an exposure position) where the shutter member 230Y allows the exposed part 212Y to be exposed from the photoreceptor unit main body 202Y.

The shutter member 230Y is in the covering position shown in FIG. 6A in a state where the photoreceptor unit 200Y is removed from the image forming apparatus main body 12. Also, the shutter member 230Y is in the covering position shown in FIG. 6A in a state where the photoreceptor unit 200Y is mounted in the image forming apparatus main body 12 and where the intermediate transfer belt unit 60 is opened with respect to the image forming apparatus main body 12. Meanwhile, the shutter member 230Y is in the exposure position shown in FIG. 6B in a state where the photoreceptor unit 200Y is mounted in the image forming apparatus main body 12 and where the intermediate transfer belt unit 60 is closed with respect to the image forming apparatus main body 12.

The shutter member 230Y is connected to the intermediate transfer belt unit 60 or the main opening/closing part 20 through the link mechanism 400 described above. Also, the shutter member 230Y is adapted to move from the exposure position to the covering position by the action of the link mechanism 400, in association with the operation for opening the intermediate transfer belt unit 60 with respect to the image forming apparatus main body 12. Meanwhile, the shutter member 230Y is adapted to move from the covering position to the exposure position by the action of the link mechanism 400, in association with the operation for closing the intermediate transfer belt unit 60 with respect to the image forming apparatus main body 12.

In this manner, when the intermediate transfer belt unit 60 is closed with respect to the image forming apparatus main body 12 in a state where the photoreceptor unit 200Y is mounted in the image forming apparatus main body 12, the photoreceptor unit 200Y comes into a state of readiness to form an image.

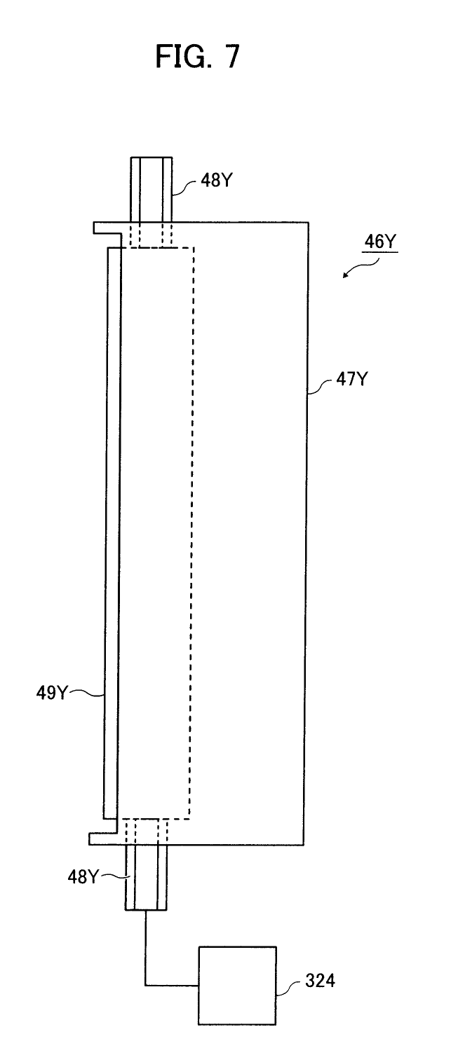

FIG. 7 is a plan view in schematic form illustrating the development device 46Y.

As shown in FIG. 7, the development device 46Y includes a development device main body 47Y, and a developing roller 49Y serving as a developer carrier is rotatably supported through bearings 48Y and 48Y in the development device main body 47Y.

The bearings 48Y and 48Y are each made of a highly heat-conductive material such as metal or heat conductive resin. More specifically, a material having a thermal conductivity of 10 W/m·K or more, and 100 W/m·K or more may be used. Here, brass having a thermal conductivity of 106 W/m·K can be given as an example of the materials for the bearings 48Y and 48Y.

Furthermore, as shown in FIG. 7, a motor 324 serving as a driving source is connected to, for example, a right shaft of the developing roller 49Y, and the developing roller 49Y receives drive transmitted from the motor 324 to rotate.

FIG. 8 illustrates the intermediate transfer belt unit 60.

The intermediate transfer belt unit 60 includes the intermediate transfer belt 62, and a frame body 100 for supporting the intermediate transfer belt 62. The frame body 100 includes a right side plate 102, a left side plate 104, and a connecting member 106 for connecting the right sideplate 102 and the left side plate 104. The above-described support rollers 64, 66, 68, 70, and 72 (see FIG. 2) are mounted on the right side plate 102 and the left side plate 104, and the intermediate transfer belt 62 is stretched over the support rollers 64, 66, 68, 70, and 72.

Also, the right side plate 102 and the left side plate 104 support the above-described first transfer rollers 80Y, 80M, 80C, and 80K (see FIG. 2).

The intermediate transfer belt unit 60 also includes the gear 92 mounted on a shaft of the support roller 70 (see FIG. 2). The gear 92 receives drive transmitted from the motor 90 serving as a driving source, thereby rotating the support roller 70 to transmit the drive to the intermediate transfer belt 62.

The intermediate transfer belt unit 60 is connected to the above-described link mechanism 400 (see FIG. 4). That is, the intermediate transfer belt unit 60 and the shutter members 230Y, 230M, 230C, and 230K are connected through the link mechanism 400. Thus, as described above, the shutter members 230Y, 230M, 230C, and 230K open and close in association with opening and closing of the intermediate transfer belt unit 60 with respect to the image forming apparatus main body 12.

Note that, in FIG. 8, in order to clarify the structure of the frame body 100, the shapes of the right side plate 102, the left side plate 104, and the connecting member 106 are simplified.

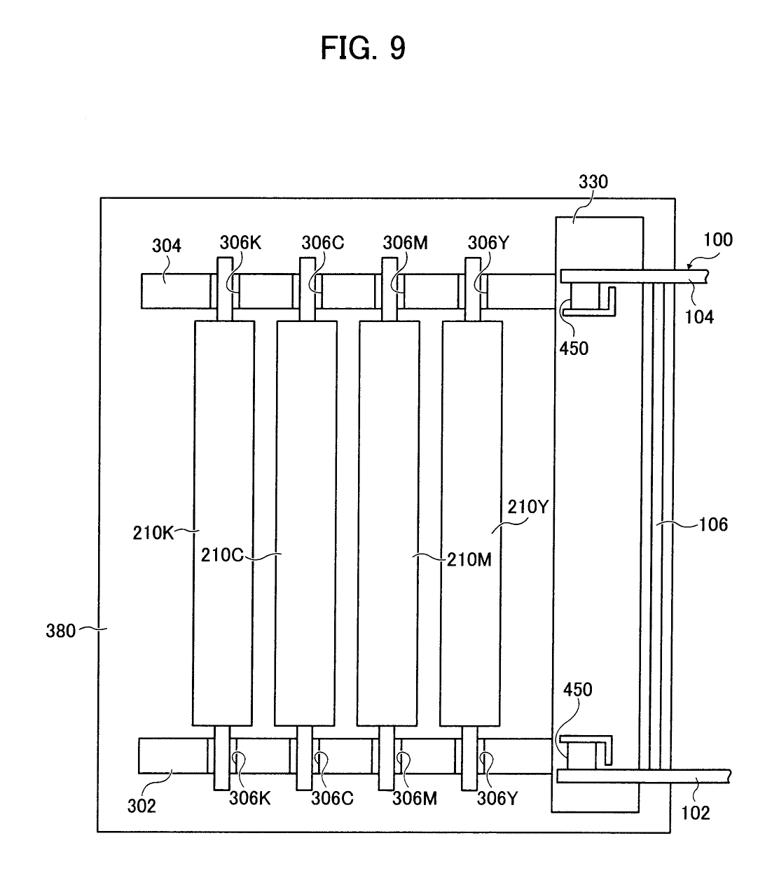

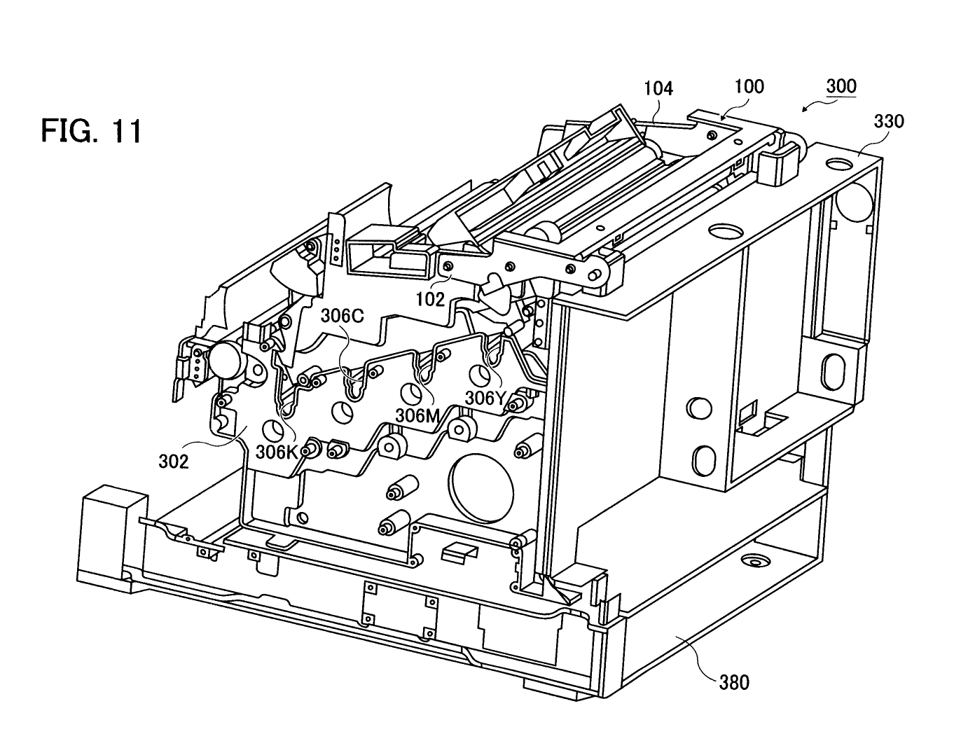

FIGS. 9 to 11 illustrate the main body frame 300. As described above, the exterior cover 14 is mounted over the main body frame 300, and the image forming apparatus main body 12 is composed of the main body frame 300 and the exterior cover 14.

The main body frame 300 includes a right side plate 302, a left side plate 304, a rear plate 330, and a base 380.

The right side plate 302 and the left side plate 304 are used as image holder supporting parts for supporting the photoreceptor drums 210Y, 210M, 210C, and 210K. In addition, the right side plate 302 and the left side plate 304 are used as a pair of side plates having the image holder support parts. On each of the right side plate 302 and the left side plate 304, four photoreceptor support grooves 306Y, 306M, 306C, and 306K are formed to be inclined from an upper end toward a lower end thereof. Shafts of the photoreceptor drums 210Y, 210M, 210C, and 210K are respectively inserted, through bearings (not shown), into the photoreceptor support grooves 306Y, 306M, 306C, and 306K formed on each of the right side plate 302 and the left side plate 304. Therefore, the photoreceptor drums 210Y, 210M, 210C, and 210K are rotatably supported by the right side plate 302 and the left side plate 304.

The right side plate 302 and the left side plate 304 are produced by, for example, molding.

Further, for example, the right side plate 302 and the left side plate 304 are made of aluminum alloy and formed by die casting. The aluminum alloy has a thermal conductivity of, for example, 96 W/m·K.

As the materials for the right side plate 302 and the left side plate 304, other materials having a thermal conductivity of 10 W/m·K or more may be used instead of aluminum alloy. Examples of the materials satisfying such conditions include magnesium alloy having a thermal conductivity of 72 W/m·K, zinc alloy having a thermal conductivity of 109 W/m·K, and copper alloy having a thermal conductivity of 207 W/m·K. In addition, the molding method is not limited to the above-described die casting, and the powder metallurgy process may be employed. For example, copper sinter having a thermal conductivity of 180 W/m·K may be employed. The powder metallurgy process includes metal injection molding (MIM).

If the materials to be used for the right side plate 302 and the left side plate 304 can be limited within the above-described conditions, metal is not necessarily required. For example, it is also possible to use heat conductive resin having a thermal conductivity of 10 W/m·K or more, such as heat conductive resin having an improved thermal conductivity in the range of from 14 to 25 W/m·K by mixing low melting point alloy into heat conductive resin having a thermal conductivity of 1.5 W/m·K with a heat conductive filler such as alumina added thereto.

If the right side plate 302 and the left side plate 304 made of those materials are used, it is possible to improve heat dissipation, as compared to the case of the use of normal resin having a thermal conductivity in the range of about 0.1 to 0.5 W/m·K. In other words, the dissipation of heat transferred from the photoreceptor drums 210Y, 210M, 210C, and 210K to the right side plate 302 and the left side plate 304 through the bearings 206Y, 206M, 206C, and 206K may be performed. Also, the dissipation of heat transferred from the developing rollers 49Y, 49M, 49C, and 49K to the right side plate 302 and the left side plate 304 through the bearings 48Y, 48M, 48C, and 48K may be performed. Furthermore, use of the side plates formed by casting or the powder metallurgy process facilitates formation of recesses corresponding to drive transmitting members to thereby facilitate arrangement of gear trains.

Also, the dissipation of heat transferred from the latent image forming device 41 to the right side plate 302 and the left side plate 304 may be performed. In addition, heat transferred from the motor 324 to the right side plate 302 and heat transferred from the motor 322 to the left side plate 304 may be dissipated.

The base 380 is used as a base for mounting the image holder supporting parts and a conveying member supporting part. The right side plate 302, the left side plate 304, and the rear plate 330 are fastened to the upper surface of the base 380 with, for example, screws.

The rear plate 330 is used as a conveying member supporting part for supporting the intermediate transfer belt 62 serving as a conveying member, and is a separate body from the right side plate 302 and the left side plate 304 to support the frame body 100 for supporting the intermediate transfer belt 62 so that the intermediate transfer belt 62 is openable and closable with respect to the exterior cover 14. That is to say, the rear plate 330 supports the intermediate transfer belt 62 through the frame body 100 so that the intermediate transfer belt 62 is opened and closed with respect to the image forming apparatus main body 12 (see FIG. 1). This allows the intermediate transfer belt unit 60 to be opened and closed with respect to the image forming apparatus main body 12, as shown in FIG. 3.

More specifically, the right side plate 102 and the left side plate 104 of the frame body 100 are mounted to the upper surface of the rear plate 330 with hinges 450 and 450, thereby supporting the intermediate transfer belt unit 60 on the rear plate 330. The hinges 450 and 450 to be used herein are the so-called one-way clutch hinges which are adapted to rotate freely in a direction to open the intermediate transfer belt 62 with respect to the image forming apparatus main body 12, and to generate rotating torque in a direction to close the intermediate transfer belt 62 with respect to the image forming apparatus main body 12.

This eliminates the need for excessive force to open the intermediate transfer belt unit 60 with respect to the image forming apparatus main body 12, and allows intermediate transfer belt unit 60 to stop at a halfway open position. Here, the halfway open position of the intermediate transfer belt unit 60 corresponds to a position between the closed position and the open position thereof with respect to the image forming apparatus main body 12 as shown in FIGS. 2 and 3, respectively. Also, since the hinges 450 and 450 generate rotating torque in a direction to close the intermediate transfer belt unit 60, the main opening/closing part 20 is prevented from falling to close by gravitation on the intermediate transfer belt unit 60 and the like.

Furthermore, the rear plate 330 is fastened to the right side plate 302 and the left side plate 304 with, for example, screws.

The intermediate transfer belt unit 60 provided with the intermediate transfer belt 62 and the like, tends to be increased in weight. Therefore, when the intermediate transfer belt unit 60 is opened or closed with respect to the image forming apparatus main body 12 and the frame body 100 is opened or closed with respect to the rear plate 330, the rear plate 330 is likely to be distorted under the weight of the intermediate transfer belt unit 60 and the like. Also, if the intermediate transfer belt unit 60 and the photoreceptor drums 210Y, 210M, 210C, and 210K are supported by a common member, there is a risk that the support member might be distorted to thereby cause the displacement of the photoreceptor drums 210Y, 210M, 210C, and 210K, resulting in the occurrence of a defect in a formed image.

In view of the foregoing, according to the first exemplary embodiment of the invention, the photoreceptor drums 210Y, 210M, 210C, and 210K are supported by the right side plate 302 and the left side plate 304, and the frame body 100 is supported by the rear plate 330. In this manner, since the photoreceptor drums 210Y, 210M, 210C, and 210K, and the frame body 100 for supporting the intermediate transfer belt 62 are supported by separate members, such image defects due to a distortion of the member for supporting the frame body 100 are less likely to be caused.

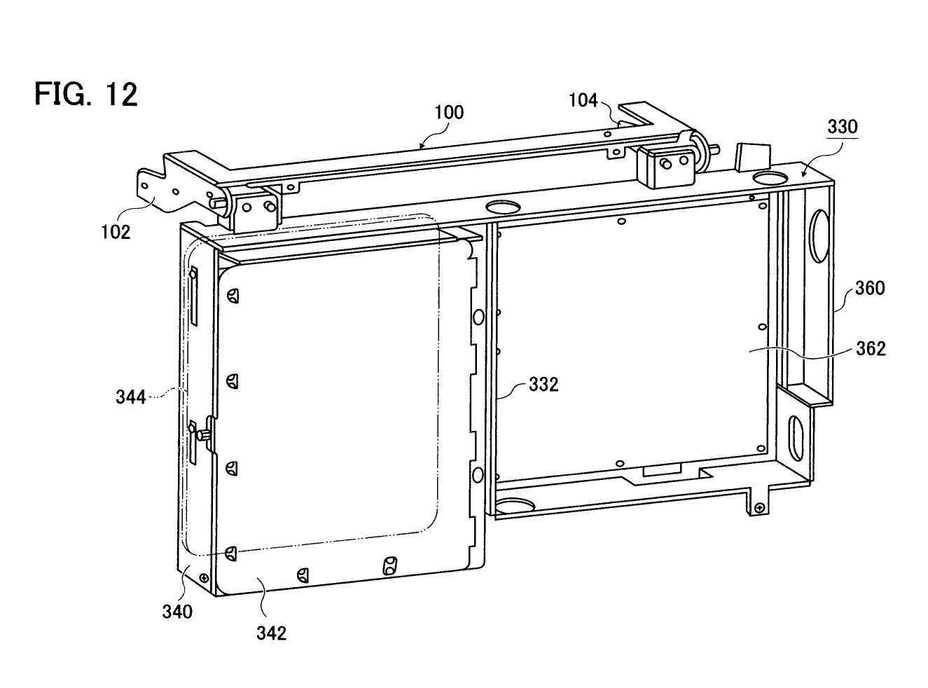

FIG. 12 illustrates the rear plate 330.

As shown in FIG. 12, the rear plate 330 includes a partition plate 332. A right box part 340 serving as a box part is formed on the right side (the left side in FIG. 12) of the partition plate 332, and a left box part 360 is formed on the left side (the right side in FIG. 12) of the partition plate 332. In this manner, box extensions extending from right to left and up and down are provided on the side opposite to the side on which the photoreceptor drums 210Y, 210M, 210C, and 210K are provided, of the rear plate 330, thereby allowing ensuring of the strength for supporting the intermediate transfer belt unit 60.

A surface on the rear side (the near side in FIG. 12) of the right box part 340 is open, and a lid member 342 is removably mounted over the open surface. Thus, the lid member 342 seals the open surface, so that the right box part 340 is closed. Also, a control substrate 344 is disposed in the right box part 340. The control substrate 344 is used as an electric substrate, and also as a control substrate to control, for example, respective members of the image forming part 40.

As described above, since the control substrate 344 is disposed within the right box part 340 in the sealed state with the lid member 342, leakage of radio waves emitted from the control substrate 344 is less likely to be caused as compared to the case where the control substrate 344 is disposed in an open space. In addition, by mounting the lid member 342, the strength of the rear plate 330 is increased as compared to the case where the lid member 342 is not mounted.

The left box part 360 is formed with side parts surrounded by plate-like members, and a surface on the rear side thereof is open. A power supply substrate 362 is mounted in the left box part 360. The power supply substrate 362 is used as an electric substrate to provide electricity to, for example, respective members of the image forming part 40.

As described above, since the power supply substrate 362 is mounted in the left box part 360 with at least one side surface opened, the power supply substrate 362 is easily cooled as compared to the case where the power supply substrate 362 is disposed in a closed space.

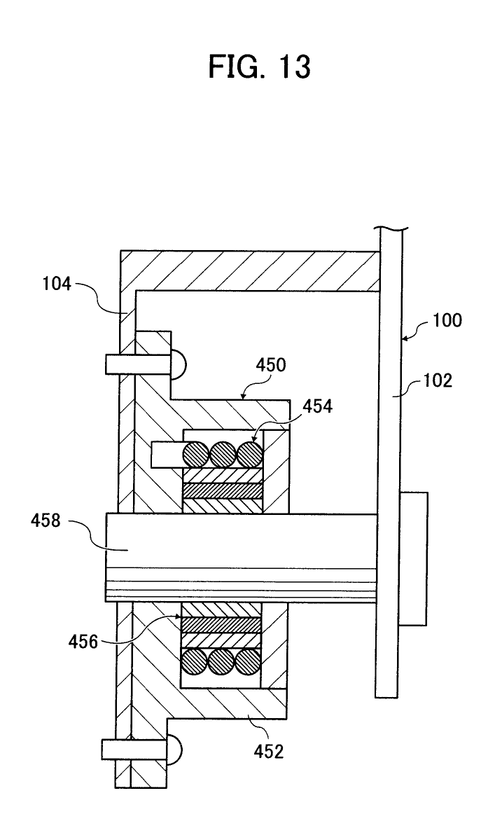

FIG. 13 illustrates the hinge 450.

The hinge 450 includes a hinge main body 452, a torque limiter mechanism 454, one-way clutch mechanism 456, and a shaft 458. The one-way clutch mechanism 456 is configured so that for rotation of the shaft 458 in one direction, the shaft 458 is opened, while for rotation of the shaft 458 in the other direction, the shaft 458 is prevented from rotating. The torque limiter mechanism 454 is provided for moving a spring thereof in a slackening direction for rotation of the shaft 458 in one direction, to thereby obtain predetermined torque.

Using the hinge 450 constituted as described above, the frame body 100 is supported, and the intermediate transfer belt unit 60 is supported. Therefore, as described above, torque is generated in a direction to close the intermediate transfer belt unit 60 with respect to the image forming apparatus main body 12, thereby causing a damper effect with the torque limiter mechanism 454. Meanwhile, when the intermediate transfer belt unit 60 is opened with respect to the image forming apparatus main body 12, the shaft 458 rotates freely and the intermediate transfer belt unit 60 can be easily opened.

According to the first exemplary embodiment described above, the image forming apparatus 10 includes the intermediate transfer belt 62 for conveying images (toner images) transferred from the photoreceptor drums 210Y, 210M, 210C, and 210K, and the intermediate transfer belt 62 is used as a conveying member. Alternatively, the image forming apparatus 10 may be configured to include, instead of the intermediate transfer belt 62, a conveyor belt for conveying a recording medium (sheet) with images (toner images) transferred from the photoreceptor drums 210Y, 210M, 210C, and 210K thereto. If the image forming apparatus 10 is configured in such a manner, the second transfer device 84 becomes unnecessary and a recording medium with images (toner images) transferred from the photoreceptor drums 210Y, 210M, 210C, and 210K is conveyed to the fixing device 50.

Next, an image forming apparatus 10 according to a second exemplary embodiment of the present invention will be described. With reference to the image forming apparatus 10 according to the second exemplary embodiment, it is noted that common portions with the image forming apparatus 10 according to the first exemplary embodiment previously described will not be described hereinafter, and the description will be limited to the differences between the two exemplary embodiments.

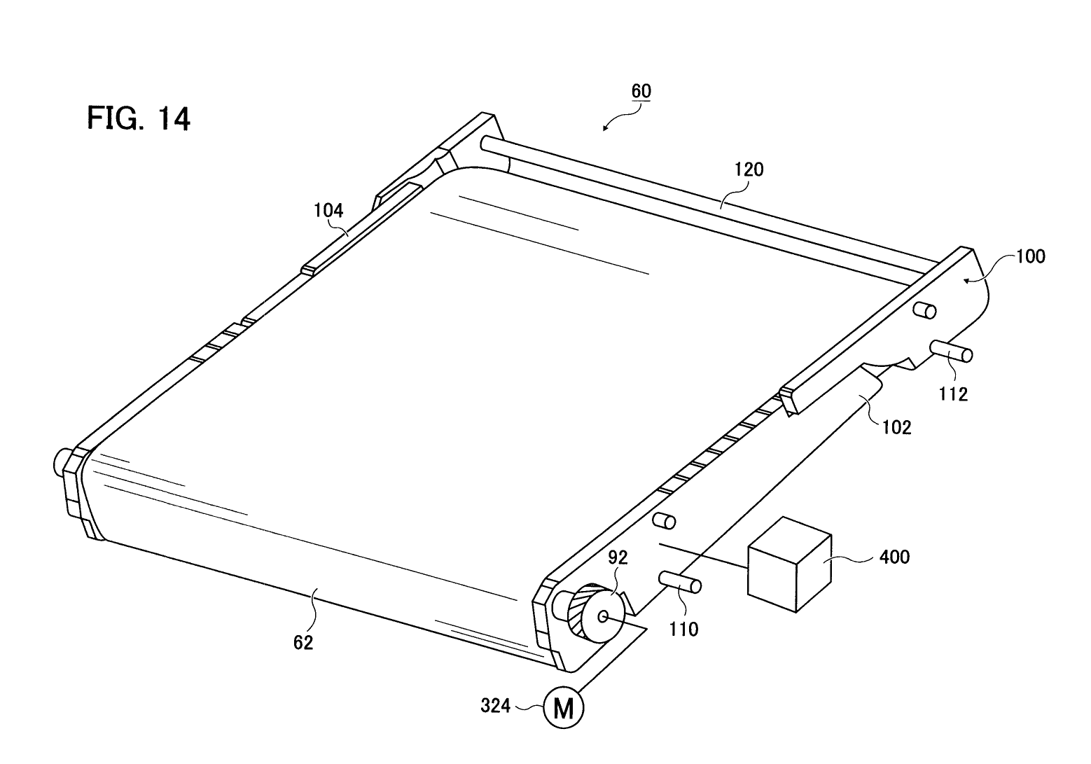

FIG. 14 illustrates the intermediate transfer belt unit 60 of the image forming apparatus 10 according to the second exemplary embodiment of the present invention. The intermediate transfer belt unit 60 includes the intermediate transfer belt 62, and is used as a conveying structure to open and close with respect to the image forming apparatus main body 12. The intermediate transfer belt unit 60 also includes the frame body 100 for supporting the intermediate transfer belt 62, in addition to the intermediate transfer belt 62. The frame body 100 includes the right side plate 102, the left side plate 104, and a connecting member 120 for connecting the right side plate 102 and the left side plate 104. The above-described support rollers 64, 66, 68, 70, and 72 (see FIG. 2) are mounted on the right side plate 102 and the left side plate 104, and the intermediate transfer belt 62 is stretched over the support rollers 64, 66, 68, 70, and 72.

Also, the right side plate 102 and the left side plate 104 support the above-described first transfer rollers 80Y, 80M, 80C, and 80K (see FIG. 2).

The intermediate transfer belt unit 60 also includes the gear 92 mounted on a shaft of the support roller 70 (see FIG. 2). The gear 92 receives drive transmitted from the motor 324 (see FIGS. 7, 10, and 11) serving as a driving source, thereby rotating the support roller 70 to transmit the drive to the intermediate transfer belt 62.

The intermediate transfer belt unit 60 is connected to the above-described link mechanism 400 (see FIG. 4). That is to say, the intermediate transfer belt unit 60 and the shutter members 230Y, 230M, 230C, and 230K are connected through the link mechanism 400. Thus, as described above, the shutter members 230Y, 230M, 230C, and 230K open and close in association with opening and closing of the intermediate transfer belt unit 60 with respect to the image forming apparatus main body 12.

On each of the right side plate 102 and the left side plate 104, a front protrusion 110 and a rear protrusion 112 are provided in an outwardly protruding manner. In FIG. 14, it is to be noted that only the front protrusion 110 and the rear protrusion 112 provided on the right side plate 102 are shown, and those formed on the left side plate 104, which are located behind the left side plate 104, are not shown.

Note that, in FIG. 14, in order to clarify the structure of the frame body 100, the shapes of the right sideplate 102, the left side plate 104, and the connecting member 120 are simplified.

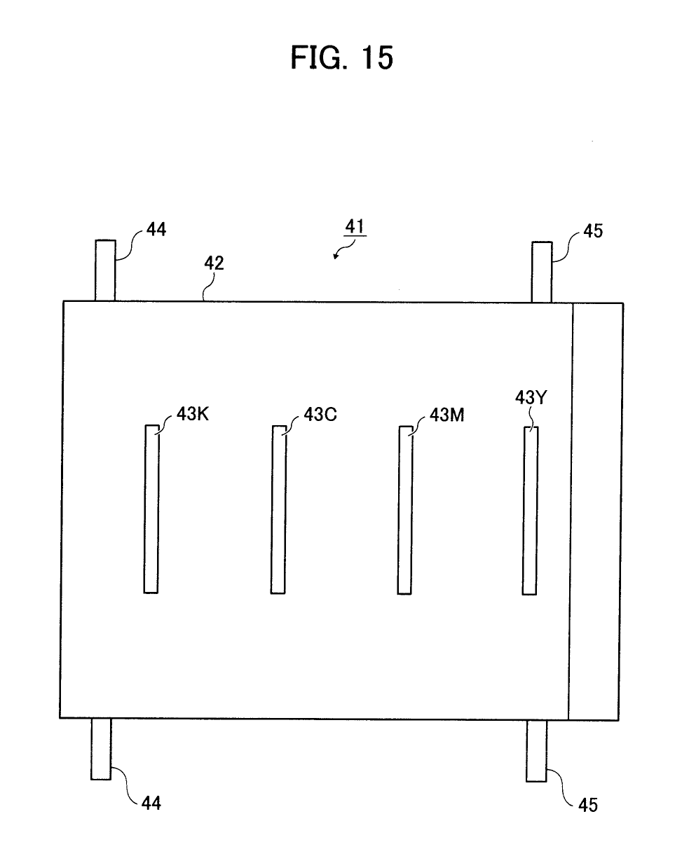

FIG. 15 is a plan view in schematic form illustrating the latent image forming device 41 of the image forming apparatus 10 according to the second exemplary embodiment of the present invention.

As shown in FIG. 15, the latent image forming device 41 includes a latent image forming device main body 42, and light passing windows 43Y, 43M, 43C, and 43K for allowing light to pass therethrough from within are formed on the latent image forming device main body 42. Also, a front protrusion 44 and a rear protrusion 45 are provided on both right and left side surfaces of the latent image forming device main body 42.

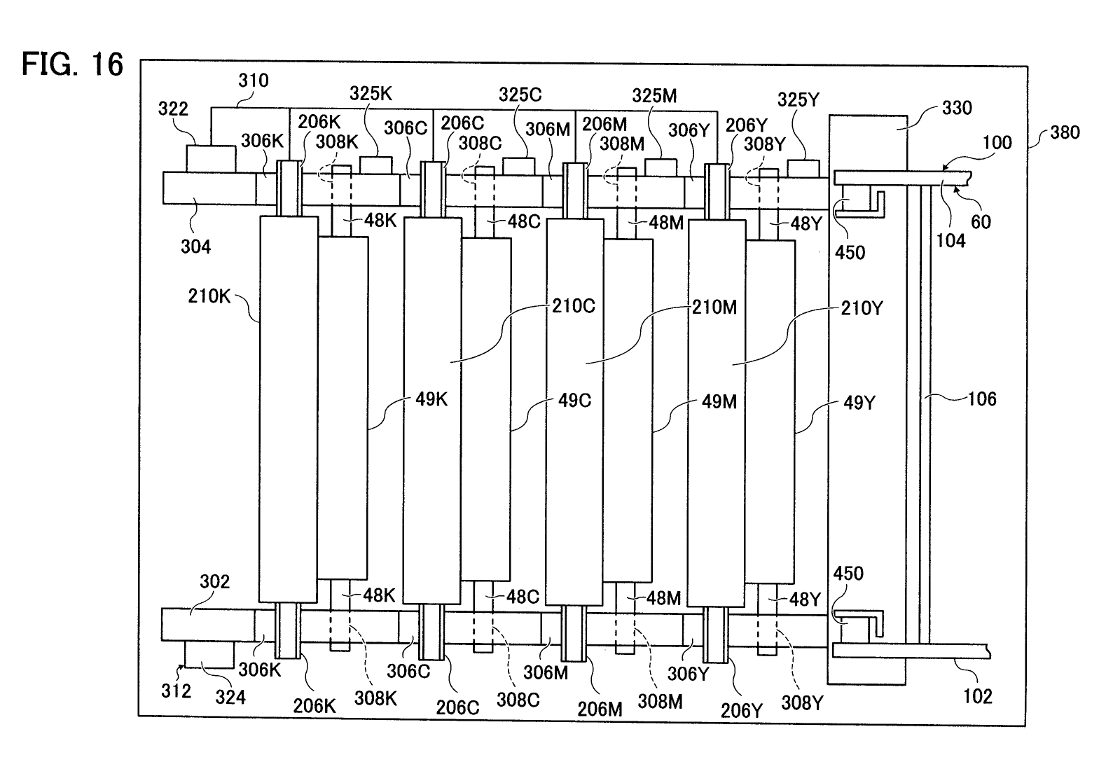

FIG. 16 is a first plan view in schematic form illustrating the main body frame 300 of the image forming apparatus 10 according to the second exemplary embodiment of the present invention. As described above, the exterior cover 14 is mounted over the main body frame 300, and the image forming apparatus main body 12 is composed of the main body frame 300 and the exterior cover 14. The main body frame 300 includes the right side plate 302, the left side plate 304, the rear plate 330, and the base 380.

The base 380 is used as a base for mounting the image holder supporting parts and a conveying member supporting part. The right side plate 302, the left side plate 304, and the rear plate 330 are fastened to the upper surface of the base 380 with, for example, screws.

The rear plate 330 is used as a supporting part for supporting the intermediate transfer belt unit 60, and is a separate body from the right side plate 302 and the left side plate 304 to support the intermediate transfer belt unit 60 so that the intermediate transfer belt unit 60 is openable and closable with respect to the image forming apparatus main body 12.

More specifically, the right side plate 102 and the left side plate 104 of the frame body 100 are mounted to the upper surface of the rear plate 330 with hinges 450 and 450, thereby supporting the intermediate transfer belt unit 60 on the rear plate 330. The hinges 450 and 450 to be used herein are the so-called one-way clutch hinges which are adapted to rotate freely in a direction to open the intermediate transfer belt 62 with respect to the image forming apparatus main body 12, and to generate rotating torque in a direction to close the intermediate transfer belt 62 with respect to the image forming apparatus main body 12.

Furthermore, the rear plate 330 is fastened to the right side plate 302 and the left side plate 304 with, for example, screws.

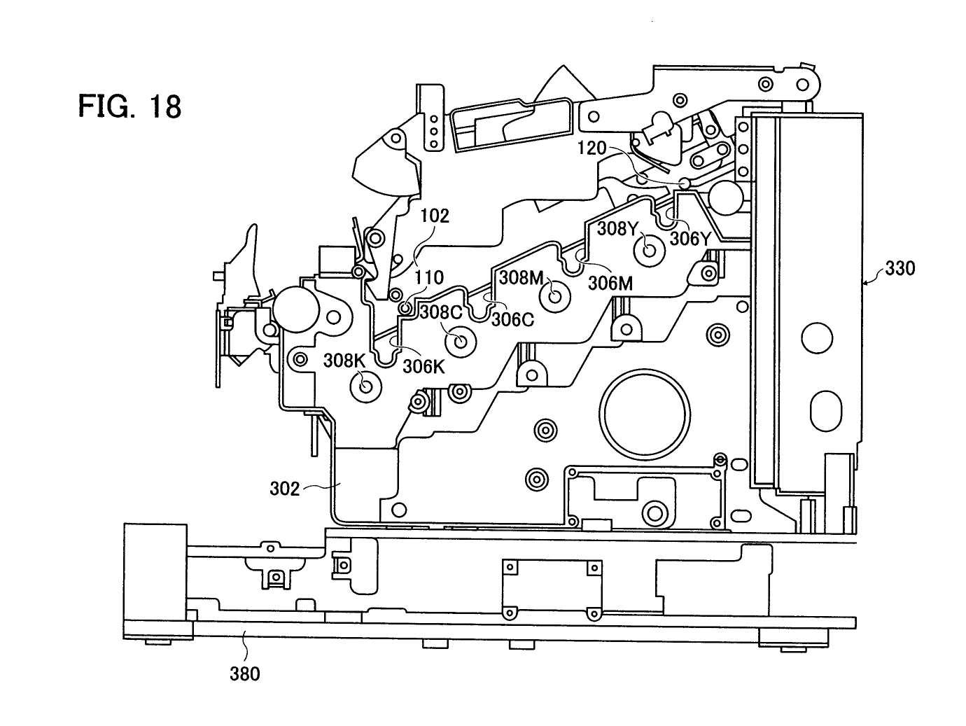

The right side plate 302 and the left side plate 304 are used as a pair of side plates on which at least one of the photoreceptor drum 210, the development device 46, and the latent image forming device 41 is mounted. On each of the right side plate 302 and the left side plate 304, photoreceptor support grooves 306Y, 306M, 306C, and 306K are formed from an upper end toward a lower end thereof (see FIG. 18). The photoreceptor support grooves 306Y, 306M, 306C, and 306K are used for supporting the photoreceptor drums 210Y, 210M, 210C, and 210K, respectively.

That is, the bearings 206Y, 206M, 206C, and 206K protruding from the right side surfaces of the photoreceptor units 200Y (see FIG. 5), 200M, 200C, and 200K are respectively inserted from above into the photoreceptor support grooves 306Y, 306M, 306C, and 306K formed on the right side plate 302. Also, the bearings 206Y, 206M, 206C, and 206K protruding from the left side surfaces of the photoreceptor units 200Y, 200M, 200C, and 200K are respectively inserted from above into the photoreceptor support grooves 306Y, 306M, 306C, and 306K formed on the left side plate 304. In this manner, the photoreceptor units 200Y, 200M, 200C, and 200K, and the photoreceptor drums 210Y, 210M, 210C, and 210K are supported by both the right side plate 302 and the left side plate 304.

Development device support holes 308Y, 308M, 308C, and 308K are formed in the right side plate 302 and the left side plate 304. The development device support holes 308Y, 308M, 308C, and 308K are used for supporting the development devices 46Y, 46M, 46C, and 46K, respectively.

That is to say, the bearings 48Y, 48M, 48C, and 48K protruding from the right side surfaces of the development device main bodies 47Y (see FIG. 7), 47M, 47C, and 47K are respectively inserted into the development device support holes 308Y, 308M, 308C, and 308K formed in the right side plate 302. Also, the bearings 48Y, 48M, 48C, and 48K protruding from the left side surfaces of the development device main bodies 47Y, 47M, 47C, and 47K are respectively inserted into the development device support holes 308Y, 308M, 308C, and 308K formed in the left side plate 304. In this manner, the development devices 46Y, 46M, 46C, and 46K, and the developing rollers 49Y, 49M, 49C, and 49K are supported by both the right side plate 302 and the left side plate 304.

A drive transmitting mechanism 312 including the motor 324 described above is mounted on the right side plate 302. The drive transmitting mechanism 312 includes, for example, a gear train, to transmit drive of the motor 324 to the intermediate transfer belt 62 with the gear train (see FIG. 14). Since the drive transmitting mechanism 312 is mounted on the right side plate 302 supporting the photoreceptor drums 210 and the developing rollers 49 in such a manner, it is unnecessary to provide another member for supporting the drive transmitting mechanism 312 in addition to the right side plate 302.

As described above, according to the second exemplary embodiment, the photoreceptor drums 210Y, 210M, 210C, and 210K and the developing rollers 49Y, 49M, 49C, and 49K are mounted on both the right side plate 302 and the left side plate 304. With this structure, it is possible to precisely regulate the positions between the photoreceptor drums 210Y, 210M, 210C, and 210K, and the developing rollers 49Y, 49M, 49C, and 49K, as compared to the case where the photoreceptor drums 210Y, 210M, 210C, and 210K and the developing rollers 49Y, 49M, 49C, and 49K are supported by members different from each other.

Furthermore, when vibrations occur, the photoreceptor drums 210Y, 210M, 210C, and 210K, the developing rollers 49Y, 49M, 49C, and 49K, the right side plate 302, and the left side plate 304 vibrate in the same cycle, and therefore image deterioration due to vibration is less likely to be caused.

Also, according to the second exemplary embodiment, the photoreceptor drums 210Y, 210M, 210C, and 210K, and the developing rollers 49Y, 49M, 49C, and 49K are different in length in the longitudinal direction thereof from each other. This allows higher-density mounting of the photoreceptor drums 210Y, 210M, 210C, and 210K, and the developing rollers 49Y, 49M, 49C, and 49K, as compared to the case where the lengths in the longitudinal direction of the photoreceptor drums 210Y, 210M, 210C, and 210K are the same as those of the developing rollers 49Y, 49M, 49C, and 49K.

A drive transmitting mechanism 310 including the motor 322 described above is mounted on the left side plate 304. The drive transmitting mechanism 310 includes, for example, a gear train, to transmit drive of the motor 322 to the photoreceptor drums 210Y, 210M, 210C, and 210K with the gear train. Since the drive transmitting mechanism 310 is mounted on the left side plate 304 supporting the photoreceptor drums 210 and the developing rollers 49 in such a manner, it is unnecessary to provide another member for supporting the drive transmitting mechanism 310 in addition to the left side plate 304.

In the second exemplary embodiment, the drive transmitting mechanism 312 is mounted on the right side plate 302, and the drive transmitting mechanism 310 is mounted on the left side plate 304. In short, the pair of side plates is provided with the respective drive transmitting mechanisms. However, only one of the side plates may be provided with a drive transmitting mechanism, namely, a drive transmitting mechanism may be provided on only one of the right side plate 302 and the left side plate 304.

As described later, the latent image forming device 41, in addition to the photoreceptor drums 210Y, 210M, 210C, and 210K, and the developing rollers 49Y, 49M, 49C, and 49K, is also mounted on the right side plate 302 and the left side plate 304. In FIG. 10, however, for the sake of convenience of illustration, the latent image forming device 41 is not shown.

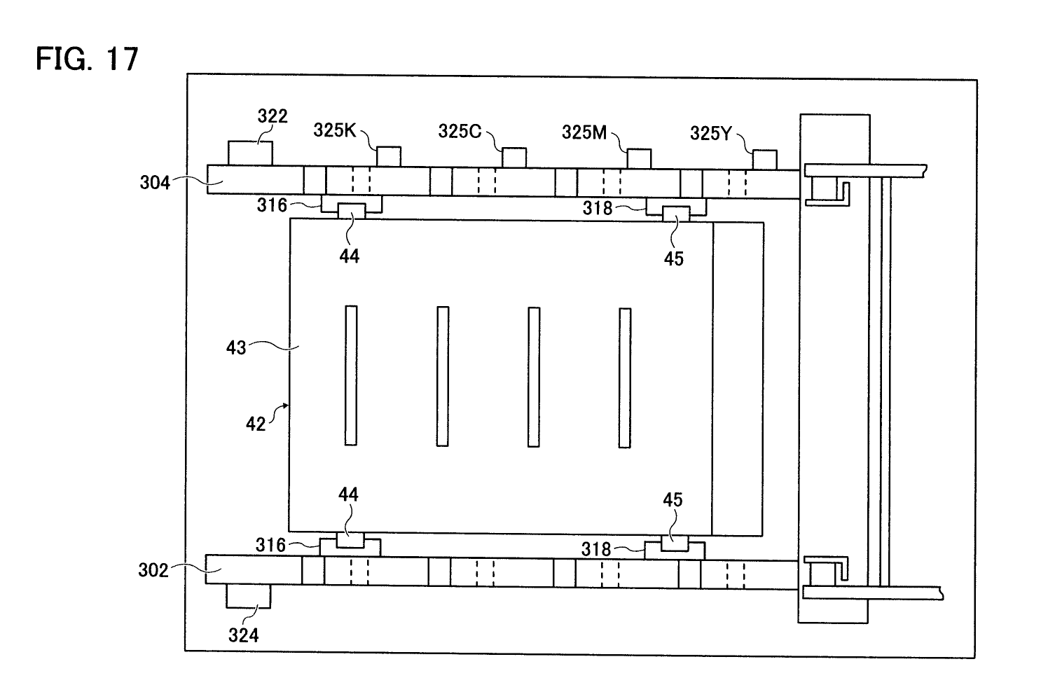

FIG. 17 is a second plan view in schematic form illustrating the main body frame 300 of the image forming apparatus 10 according to the second exemplary embodiment of the present invention.

As shown in FIG. 17, on each of the right side plate 302 and the left side plate 304, a front support part 316 and a rear support part 318 are formed in an inwardly protruding manner. The front support part 316 and the rear support part 318 are used for supporting the latent image forming device 41. That is, the latent image forming device 41 is supported by the right side plate 302 and the left side plate 304 such that the front protrusions 44 and 44 of the latent image forming device 41 are placed on the front support parts 316 and 316, respectively, and that the rear protrusions 45 and 45 of the latent image forming device 41 are placed on the rear support parts 318 and 318, respectively. The front protrusions 44 and 44 are pressed against the front support parts 316 and 316, and the rear protrusions 45 and 45 are pressed against the rear support parts 318 and 318, by press members (not shown) such as coil springs.

As described above, the photoreceptor drums 210Y, 210M, 210C, and 210K, and the developing rollers 49Y, 49M, 49C, and 49K are mounted on both the right side plate 302 and the left side plate 304. In FIG. 17, however, for the sake of convenience of illustration, those are not shown.

FIG. 18 is a first side view illustrating the right side plate 302 provided in the image forming apparatus 10 according to the second exemplary embodiment of the present invention.

As shown in FIG. 18, the above-described photoreceptor support grooves 306Y, 306M, 306C, and 306K are formed on the right side plate 302. The development device support holes 308Y, 308M, 308C, and 308K are also formed in the right side plate 302.

The right side plate 302 supports, from the lower side in the direction of gravitational force, the front protrusion 110 and the rear protrusion 112 provided on the intermediate transfer belt unit 60 being in the closed state with respect to the image forming apparatus main body 12. In the same manner as the right side plate 302, the left side plate 304 supports, from the lower side in the direction of gravitational force, the front protrusion 110 and the rear protrusion 112 provided on the intermediate transfer belt unit 60. Thus, a distortion of the intermediate transfer belt unit 60 can be less likely to occur as compared to the case where the intermediate transfer belt unit 60 is not supported by the right side plate 302 and the left side plate 304. Also, a recess having a shape corresponding to a gear train serving as a drive transmitting member (not shown) is formed on the right side plate 302, and the gear train is inserted into and disposed in the recess.

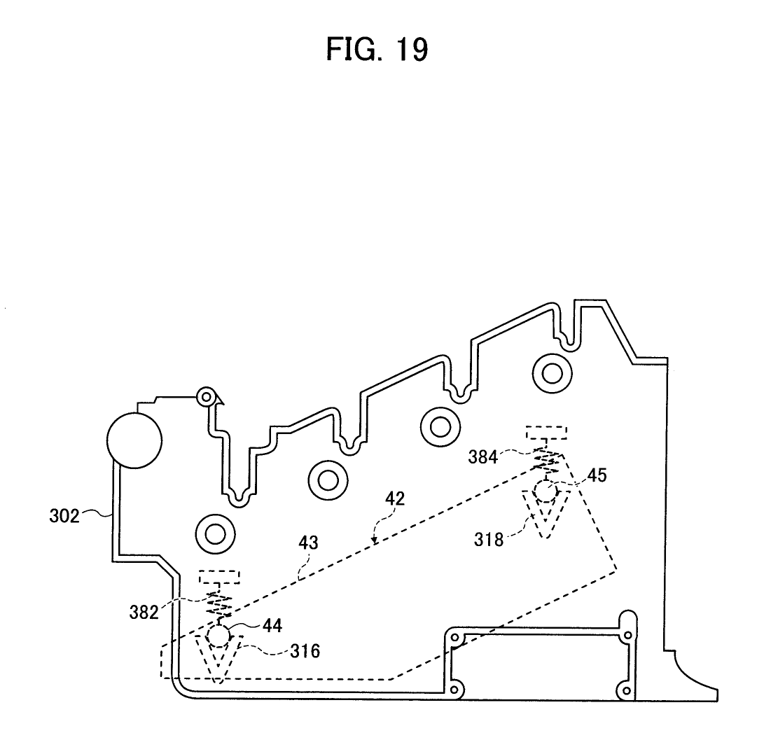

FIG. 19 is a second side view illustrating the right side plate 302.

As shown in FIG. 19, the above-described front support part 316 and rear support part 318 are formed on the internal surface of the right side plate 302, and the front protrusion 44 and the rear protrusion 45 formed on the latent image forming device main body 42 are placed on the front support part 316 and the rear support part 318, respectively. Also, the front protrusion 44 is pressed against the front support part 316, and the rear protrusion 45 is pressed against the rear support part 318, by press members 382 and 384 composed of coil springs.

As described above, according to the second exemplary embodiment, the photoreceptor drums 210Y, 210M, 210C, and 210K, and the latent image forming device 41 are mounted on both the right side plate 302 and the left side plate 304. With this structure, it is possible to precisely regulate the positions between the photoreceptor drums 210Y, 210M, 210C, and 210K and the latent image forming device 41, as compared to the case where the photoreceptor drums 210Y, 210M, 210C, and 210K and the latent image forming device 41 are supported by members different from each other.

Furthermore, when vibrations occur, the photoreceptor drums 210Y, 210M, 210C, and 210K, the latent image forming device 41 vibrate in the same cycle, and therefore image deterioration due to vibration is less likely to be caused.

The right side plate 302 and the left side plate 304 are made of aluminum alloy and formed by die casting. The aluminum alloy has a thermal conductivity of, for example, 96 W/m·K.

As the materials for the right side plate 302 and the left side plate 304, other materials having a thermal conductivity of 10 W/m·K or more may be used instead of aluminum alloy. Examples of the materials satisfying such conditions include magnesium alloy having a thermal conductivity of 72 W/m·K, zinc alloy having a thermal conductivity of 109 W/m·K, and copper alloy having a thermal conductivity of 207 W/m·K. In addition, the molding method is not limited to the above-described die casting and the powder metallurgy process may be employed. For example, copper sinter having a thermal conductivity of 180 W/m·K may be employed. The powder metallurgy process includes metal injection molding (MIM).

If the materials to be used for the right side plate 302 and the left side plate 304 can be limited within the above-described conditions, metal is not necessarily required. For example, it is also possible to use heat conductive resin having a thermal conductivity of 10 W/m·K or more, such as heat conductive resin having an improved thermal conductivity in the range of from 14 to 25 W/m·K by mixing low melting point alloy into heat conductive resin having a thermal conductivity of 1.5 W/m·K with a heat conductive filler such as alumina added thereto.

If the right side plate 302 and the left side plate 304 made of those materials are used, it is possible to improve heat dissipation, as compared to the case of the use of normal resin having a thermal conductivity in the range of about 0.1 to 0.5 W/m·K. In other words, the dissipation of heat transferred from the photoreceptor drums 210Y, 210M, 210C, and 210K to the right side plate 302 and the left side plate 304 through the bearings 206Y, 206M, 206C, and 206K may be performed. Also, the dissipation of heat transferred from the developing rollers 49Y, 49M, 49C, and 49K to the right side plate 302 and the left side plate 304 through the bearings 48Y, 48M, 48C, and 48K may be performed. Furthermore, use of the side plates formed by casting or the powder metallurgy process facilitates formation of recesses corresponding to drive transmitting members to thereby facilitate arrangement of gear trains.

Also, the dissipation of heat transferred from the latent image forming device 41 to the right side plate 302 and the left side plate 304 may be performed. In addition, heat transferred from the motor 324 to the right side plate 302 and heat transferred from the motor 322 to the left side plate 304 may be dissipated.

As described above, the present invention can be applied to image forming apparatuses such as copying machines, printers, and facsimile machines.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
an image holder that holds an image;
a conveying member that conveys an image transferred from the image holder or a recording medium with the image transferred from the image holder thereto;
an image holder supporting part that supports the image holder; and
a conveying member supporting part that is a separate body from the image holder supporting part and supports the conveying member such that the conveying member is openable and closable.

2. The image forming apparatus according to claim 1, further comprising a base that fixes the image holder supporting part and the conveying member supporting part,
wherein the image holder supporting part includes a pair of side plates, and
the conveying member supporting part is fixed to two side plates constituting the pair of side plates.

3. The image forming apparatus according to claim 1, wherein the conveying member supporting part includes at least one box-shaped box part.

4. The image forming apparatus according to claim 3, wherein an electric substrate is disposed within the at least one box part.

5. The image forming apparatus according to claim 3, wherein the at least one box part is closable.

6. The image forming apparatus according to claim 3, wherein the conveying member supporting part includes at least two of the box parts, one of the two box parts being closed with a control substrate disposed therein, and the other of the two box parts with a power supply substrate disposed therein and with at least one face opened.

7. The image forming apparatus according to claim 1, wherein the conveying member supporting part supports the conveying member through supporting sections that rotate freely in a direction to open the conveying member and generate rotating torque in a direction to close the conveying member.

8. An image forming apparatus comprising:
an image holder;
a latent image forming device that forms a latent image on the image holder;
a development device that develops the latent image carried by the image holder; and
a pair of side plates provided with at least one of the image holder, the latent image forming device, and the development device,
the pair of side plates having a thermal conductivity of 10 W/m·K or more and being formed by casting or a powder metallurgy process.

9. The image forming apparatus according to claim 8, wherein the pair of side plates is provided with at least the image holder and the latent image forming device.

10. The image forming apparatus according to claim 8, wherein the pair of side plates is provided with at least the image holder and the development device.

11. The image forming apparatus according to claim 8, wherein the image holder and the development device are different in length in a longitudinal direction from each other.

12. The image forming apparatus according to claim 8, further comprising a conveying structure including a conveying member that conveys at least one of an image transferred from the image holder and a recording medium with the image transferred from the image holder thereto, and opening and closing with respect to a main body of the image forming apparatus,
wherein the conveying structure is supported by the pair of side plates when the conveying structure is closed with respect to the image forming apparatus main body.

13. The image forming apparatus according to claim 8, wherein at least one of the pair of side plates is provided with a driving mechanism that drives at least one of the image holder, the development device, and the conveying member.

14. The image forming apparatus according to claim 13, wherein a recess for allowing a motor provided in the driving mechanism to be mounted therein is formed on at least one of the pair of side plates.

15. The image forming apparatus according to claim 8,
wherein both the image holder and the development device are plurally provided, and
at least one of the pair of side plates is provided with a plurality of motors that drive one of at least one of the image holders and the development devices.

16. An image forming apparatus comprising:
an image holder;
a latent image forming device that forms a latent image on the image holder;
a development device that develops the latent image carried by the image holder; and
a pair of side plates provided with at least one of the image holder, the latent image forming device, and the development device,
the pair of side plates being made of heat conductive resin having a thermal conductivity of 10 W/m·K or more.

17. The image forming apparatus according to claim 16, wherein the pair of side plates is provided with at least the image holder and the latent image forming device.

18. The image forming apparatus according to claim 16, wherein the pair of side plates is provided with at least the image holder and the development device.

19. The image forming apparatus according to claim 16, wherein the image holder and the development device are different in length in a longitudinal direction from each other.

20. The image forming apparatus according to claim 16, further comprising a conveying structure including a conveying member that conveys at least one of an image transferred from the image holder and a recording medium with the image transferred from the image holder thereto, and opening and closing with respect to a main body of the image forming apparatus,
wherein the conveying structure is supported by the pair of side plates when the conveying structure is closed with respect to the image forming apparatus main body.

21. The image forming apparatus according to claim 16, wherein at least one of the pair of side plates is provided with a driving mechanism that drives at least one of the image holder, the development device, and the conveying member.

22. The image forming apparatus according to claim 21, wherein a recess for allowing a motor provided in the driving mechanism to be mounted therein is formed on at least one of the pair of side plates.

23. The image forming apparatus according to claim 16,
wherein both the image holder and the development device are plurally provided, and
at least one of the pair of side plates is provided with a plurality of motors that drive one of at least one of the image holders and the development devices.

24. An image forming apparatus comprising:
an image forming apparatus main body;
an image holder disposed in the image forming apparatus main body;
a latent image forming device that forms a latent image on the image holder;
a development device that develops the latent image carried by the image holder; and
a conveying member that conveys a developer image transferred from the image holder or a recording medium with the developer image transferred from the image holder thereto,
the image forming apparatus main body including:
a pair of side plates provided with at least one of the image holder, the latent image forming device, and the development device, the pair of side plates having a thermal conductivity of 10 W/m·K or more and being formed by casting or a powder metallurgy process; and
a conveying member supporting part that is a separate body from the pair of side plates and supports the conveying member such that the conveying member is openable and closable.

25. An image forming apparatus comprising:
an image forming apparatus main body;
an image holder disposed in the image forming apparatus main body;
a latent image forming device that forms a latent image on the image holder;
a development device that develops the latent image carried by the image holder; and
a conveying member that conveys a developer image transferred from the image holder or a recording medium with the developer image transferred from the image holder thereto,
the image forming apparatus main body including:
a pair of side plates provided with at least one of the image holder, the latent image forming device, and the development device, the pair of side plates being made of heat conductive resin having a thermal conductivity of 10 W/m·K or more; and
a conveying member supporting part that is a separate body from the pair of side plates and supports the conveying member such that the conveying member is openable and closable.
